(19) United States
(12) Patent Application Publication
(10) Pub. No.: US 2026/0331010 A1
(43) Pub. Date: Oct. 22, 2026

(54) ROTATABLE DISPLAY DEVICE

(71) Applicant: LG ELECTRONICS INC., Seoul (KR)

(72) Inventor: Soobeom LEE, Seoul (KR)

(73) Assignee: LG ELECTRONICS INC., Seoul (KR)

(21) Appl. No.: 19/105,612

(22) PCT Filed: Aug. 22, 2022
(86) PCT No.: PCT/KR2022/012471

§ 371 Date: Feb. 21, 2025

(51) Int. Cl. G09G 3/00

(52) U.S. Cl. CPC G09G 3/001; G09G 2320/02

(57) ABSTRACT

The present disclosure is applicable to technical fields related to display devices and relates to, for example, a rotatable display device using light-emitting diodes (LED) that are a semiconductor light-emitting element. The present disclosure may comprise: a fixed unit comprising a motor; a rotation unit which is located on the fixed unit and is rotated by the motor; a light source module which is coupled to the rotation unit and comprises a light-emitting element array which displays an image by using an afterimage caused by the rotation of the rotation unit; an encoder which comprises a scaler fixed to any one of the fixed unit and the rotation unit and having a plurality of slits formed therein, and which outputs a synchronization signal corresponding to positions of the plurality of slits according to the relative motion generated by the fixed unit and the rotation unit; and an image processing unit for generating an image output signal that controls light emission of the light source module at a time point including a delay time including an average value of the deviation in the synchronization signal output from the encoder.

### TECHNICAL FIELD

The present disclosure is applicable to display-device-related technical fields, and relates to a rotating display device using a light-emitting diode (LED), which is a semiconductor light-emitting element.

### BACKGROUND ART

When a light-emitting module (light source bar) in which light sources are arranged one-dimensionally is driven at a high speed, various characters, graphics, and videos may be reproduced due to the after-image effect on the human eye. Light-emitting diodes (LEDs) are usually used as these light sources.

In general, when still images are continuously displayed at a rate of 24 or more sheets per second, a viewer recognizes the same as a video, and a conventional image display device is configured to display still images at a rate of 30 to 60 frames per second, so that a viewer may recognize the same as a video. As the number of still images displayed per second increases, a viewer may experience a smoother video.

In this way, a display device that implements images while rotating light sources is called a rotating after-image display device.

Such a rotating after-image display device includes a fixed unit and a rotary unit. For example, a part that receives external power, a driving circuit of a motor, etc. may be located in the fixed unit, and a display driving device, a light source bar, etc. may be located in the rotary unit. Therefore, a power supply of the rotating after-image display device may include a part that transmits electric power (power) from the fixed unit to the rotary unit.

When implementing the rotating after-image display device, the rotational speed of the rotary unit and the synchronization of a scanning screen by the light sources should coincide with each other so that a desired image or video may always be reproduced at a constant position.

There may be various methods of synchronizing the image and a specific position of the light sources, and for example, an optical encoder using infrared light may be applied.

Although scanning is performed by synchronizing the image and the specific position of the light sources using the encoder, if the rotational speed of the rotary unit is changed while the light sources rotate, the image may momentarily shake or the image may be distorted in a section in which the speed is changed.

In addition, the rotation axis of a display and the axis of the encoder may not perfectly coincide due to a mechanical tolerance between the rotating display device and the encoder, and may thus cause screen shaking of the display.

For example, if a scaler is used in the encoder, the scaler and the rotary unit in which a light source module is installed are installed so that the axes of the scaler and the rotary unit coincide, but a certain mechanical tolerance may occur between the central axis of the scaler and the axis of the rotary unit. That is, if the axis of the scaler deviates from the axis of the rotary unit, a reference signal may not be generated at the correct timing, and thus, screen shaking may occur.

Therefore, there is required a method of implementing a display in which screen shaking does not occur by accurately synchronizing an image and a specific position of light sources regardless of axis deviation (tolerance) that inevitably occurs between the central axis of an encoder and the axis of a rotary unit.

### DISCLOSURE

### Technical Task

A technical task to be solved by the present disclosure is to provide a rotating display device capable of alleviating screen shaking caused by deviation of the axis of an optical encoder from a rotary unit when synchronizing the screen of a rotating display using the encoder.

### Technical Solutions

In order to solve the above technical tasks, a first aspect of the present disclosure provides a rotating display device including a fixed unit including a motor, a rotary unit located on the fixed unit and rotated by the motor, a light source module coupled to the rotary unit and including a light-emitting element array configured to display an image using an after-image caused by the rotation of the rotary unit, an encoder including a scaler fixed to any one of the fixed unit and the rotary unit and having a plurality of slits formed therein, and configured to output synchronization signals corresponding to positions of the plurality of slits caused by relative motion generated by the fixed unit and the rotary unit, and an image processor configured to generate an image output signal configured to control light emission of the light source module at a point in time including a delay time including an average value of deviations of the synchronization signals output from the encoder.

As an exemplary embodiment, the synchronization signals may include a first synchronization signal and a second synchronization signal corresponding to two slits among the plurality of slits.

As an exemplary embodiment, the image processor may be configured to generate the image output signal at a point in time obtained by adding the delay time to a detection time of a signal first detected among the first synchronization signal and the second synchronization signal.

As an exemplary embodiment, the encoder may include a first header configured to generate the first synchronization signal and a second header configured to generate the second synchronization signal.

As an exemplary embodiment, the first header may be located at a first side of the scaler and include a first light emitter and a first light receiver, and the second header may be located at a second side of the scaler and include a second light emitter and a second light receiver.

As an exemplary embodiment, the first side may be located at an opposite point to the second side on the scaler.

As an exemplary embodiment, the delay time may include a basic delay time corresponding to a time from a point in time when the synchronization signals are output to a point in time when the light source module actually emits light.

As an exemplary embodiment, the image processor may be configured to output the image output signal after the delay time obtained by adding the basic delay time and the average value to a detection time of a signal first detected among the first synchronization signal and the second synchronization signal.

As an exemplary embodiment, the scaler may have a disc shape configured such that the plurality of slits is formed in a circumferential direction thereof.

As an exemplary embodiment, the encoder may include a light emitter configured to continuously emit light, and a light receiver configured to receive the light emitted from the light emitter.

As an exemplary embodiment, the light source module may include a light-emitting element array coupled to the rotary unit, and disposed in a longitudinal direction on at least one panel arranged radially or at least one panel arranged along a cylindrical surface.

In order to solve the above technical tasks, a second aspect of the present disclosure provides a rotating display device including a fixed unit including a motor, a rotary unit located on the fixed unit and rotated by the motor, a light source module coupled to the rotary unit and including a light-emitting element array configured to display an image using an after-image caused by the rotation of the rotary unit, an encoder including a plurality of slits and configured to output synchronization signals including a first synchronization signal and a second synchronization signal corresponding positions of to two slits among the plurality of slits, caused by relative motion generated by the fixed unit and the rotary unit, and an image processor configured to generate an image output signal to control light emission of the light source module at a point in time including a delay time including an average value of deviations of the first synchronization signal and the second synchronization signal output from the encoder.

### Advantageous Effects

According to one embodiment of the present disclosure, the following effects are provided.

First, according to one embodiment of the present disclosure, an image output signal for controlling light emission of a light source module is generated at a delay time including an average value of deviations of synchronization signals output from an encoder, and thereby, an encoder signal at a normal position that is always delayed by a constant amount of time may be processed.

Therefore, even if the axis of the encoder deviates, the normal position is calculated and the processed encoder signal is output after delay of a certain time, thereby being capable of alleviating or preventing screen shaking.

As such, according to one embodiment of the present disclosure, regardless of axis deviation (tolerance) that inevitably occurs between the central axis of an encoder and the axis of a rotary unit, screen shaking may be alleviated by accurately synchronizing an image and a specific position of light sources.

Furthermore, the present disclosure may have additional technical effects not mentioned herein, and those skilled in the art will understand these effects through the entire intent of the description and drawings.

### DESCRIPTION OF DRAWINGS

FIG. 1 is a perspective view illustrating a first embodiment of a rotating display device applicable to the present disclosure.

FIG. 2 is a perspective view illustrating a second embodiment of a rotating display device applicable to the present disclosure.

FIG. 3 is a perspective view showing the front surface of a light source module according to a first embodiment of the present disclosure.

FIG. 4 is a perspective view showing the rear surface of the light source module according to the first embodiment of the present disclosure.

FIG. 5 is an enlarged view of portion A in FIG. 3.

FIG. 6 is a cross-sectional view of the light source module according to the first embodiment of the present disclosure.

FIG. 7 is a block diagram of the rotating display device according to one embodiment of the present disclosure.

FIG. 8 is a schematic perspective view illustrating a state in which an encoder is applied to a rotating display device according to the first embodiment of the present disclosure.

FIGS. 9 to 12 are views for explaining a phenomenon that occurs if the axis of a scaler deviates from the axis of a rotary unit in the rotating display device.

FIG. 13 is a schematic perspective view illustrating a state in which an encoder is applied to a rotating display device according to a second embodiment of the present disclosure.

FIGS. 14 and 15 are views illustrating one example of a process of generating an image output signal in the rotating display device according to the second embodiment of the present disclosure.

FIGS. 16 and 17 are views illustrating another example of a process of generating an image output signal in the rotating display device according to the second embodiment of the present disclosure.

FIG. 18 is a flowchart of a process of generating an image output signal.

FIG. 19 is a table showing actual photographed states of light source modules of the rotating display devices according to the embodiments of the present disclosure.

### BEST MODE FOR DISCLOSURE

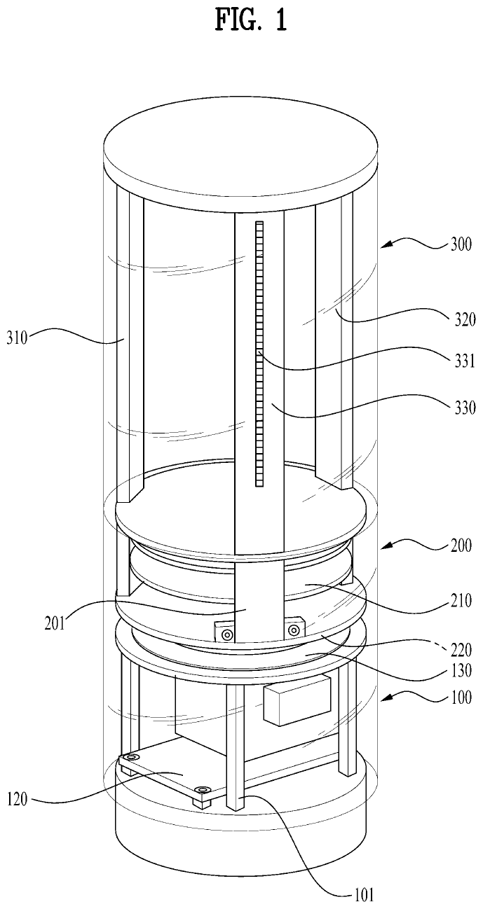

FIG. 1 is a perspective view illustrating a first embodiment of a rotating display device applicable to the present disclosure;
FIG. 1 illustrates a cylindrical rotating display device in which light-emitting element arrays 311 are respectively and longitudinally provided at one or more panels 310, 320 and 333 disposed along the circumferential surface of the rotating display device. In FIG. 1, only the light-emitting element array 311 that is provided at the front panel 330 is viewable. Although the light-emitting element arrays provided at the left panel 310 and the right panel 320 are not shown in the drawing, light-emitting element arrays each having the same structure may also be applied to the left panel 310 and the right panel 320.

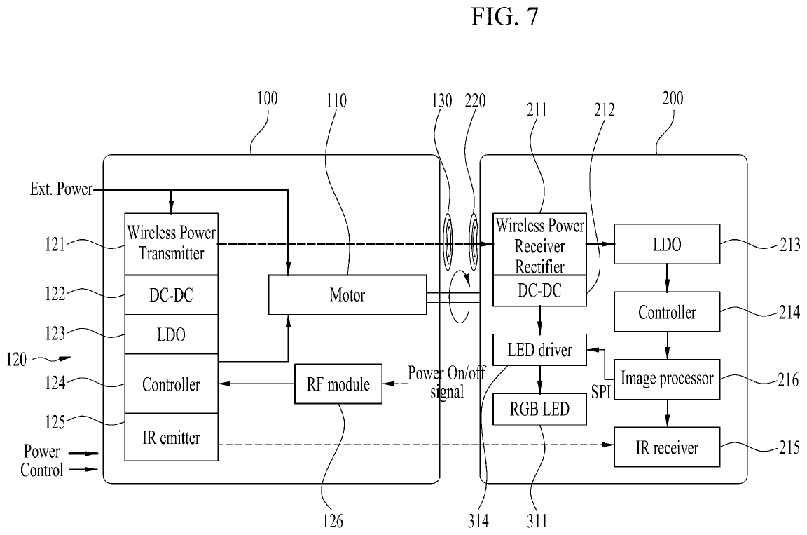

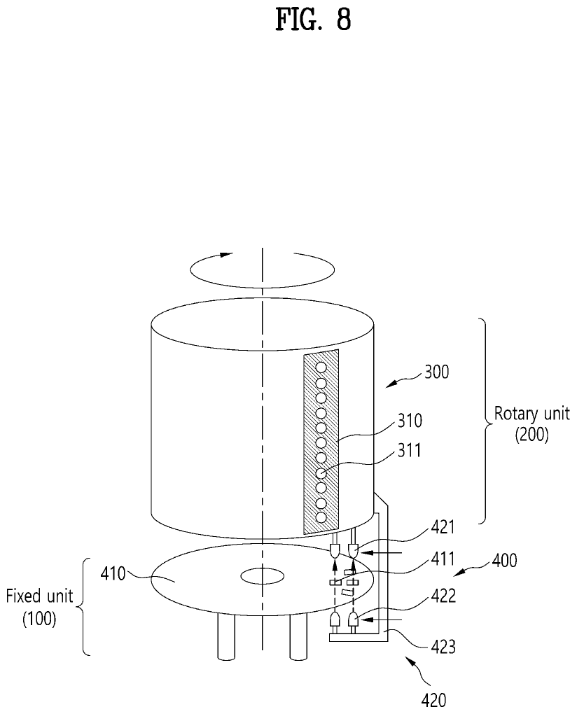

Broadly speaking, the rotating display device may include a fixed unit 100 including a motor 110 (see FIG. 7), a rotary unit 200, which is positioned on the fixed unit 100 and is rotated by the motor 110, and a light source module 300, which is coupled to the rotary unit 200 and includes the light-emitting element arrays 311 mounted on the panel 310, 320, and 330 (hereinafter, referred to as “first panels”) to embody a display configured to display an after-image by rotation thereof.

Here, the light source module 300 may include the light-emitting element arrays 311, which are respectively and longitudinally mounted on the one of more bar-shaped first panels 310, 320 and 330, which are disposed on the cylindrical outer circumferential surface at regular intervals.

In FIG. 1, the light source module 300 may include three first panels 310, 320 and 330, each of which includes the light-emitting element array 311 (hereinafter, referred to as a “first light-emitting element array”). However, this embodiment is only one example, and the light source module 300 may include one or more panels.

The first light-emitting element array 311 may be constructed such that pixels are longitudinally arranged on each of the first panels 310, 320 and 330. Here, subpixels constituting each of the pixels may be arranged in a direction perpendicular to the longitudinal direction. Furthermore, the subpixels constituting each of the pixels may be arranged in a direction parallel to the longitudinal direction.

The subpixels of each of the pixels may sequentially emit light in the pixel.

A detailed description of the first light-emitting element array 311 included in the light source module 300 will be given later.

The first panels 310, 320 and 330, which constitutes the light source module 300, may be embodied as printed circuit boards (PCBs). In other words, each of the first panels 310, 320 and 330 may have the function of a printed circuit board. The light-emitting array of each of the first panels 310, 320 and 330 may constitute a unit pixel and may be arranged in the longitudinal direction of the panel.

The panel equipped with the light-emitting element array may be rotated so as to realize a display using an after-image. Realization of the after-image will be described in detail later.

Although the light source module 300 may be constituted by a plurality of first panels 310, 320 and 330, as described above, the light source module 300 may also be constituted by a single panel equipped with a light-emitting array. When the light source module 300 is constituted by a plurality of panels, as shown in FIG. 1, a plurality of sub-images, which are allocated to the plurality of panels, may realize one single frame image. Accordingly, the light source module 300 may be rotated at a rotational speed lower than in the case in which the same frame is realized by a single panel.

The fixed unit 100 may constitute a frame structure. In other words, the fixed unit 100 may include a plurality of frames 101, which are designed to be coupled to each other so as to constitute the fixed unit 100.

The frame structure may provide a space in which the motor 110 is mounted and a space in which a power supply 120, an RF module 126 (see FIG. 7), and the like are mounted.

Furthermore, the fixed unit 100 may be provided with a weight (not shown) configured to reduce the influence of high-speed rotation of the rotary unit 200.

Similar to the fixed unit 100, the rotary unit 200 may also constitute a frame structure. In other words, the rotary unit 200 may include a plurality of frames 201, which are designed to be coupled to each other to constitute the rotary unit 200.

The frame structure may provide a space in which a drive circuit 210 configured to drive the first light-emitting array 311 to realize a display is mounted.

The driving shaft of the motor 110 may be fixed to a shaft-fixing portion (not shown) formed at the frames 201 of the rotary unit 200. As a result, the driving shaft of the motor 110 may be positioned coaxially with the rotational center of the rotary unit 200.

The light source module 300 may be fixed to the upper sides of the frames 201.

Power may be transmitted between the fixed unit 100 and the rotary unit 200 via wireless power transmission. To this end, a transmission coil 130 may be mounted on the upper side of the fixed unit 100 so as to transmit power in a wireless manner, and a receiving coil 220 may be mounted on the lower side of the rotary unit 200 at a position that faces the transmission coil 130.

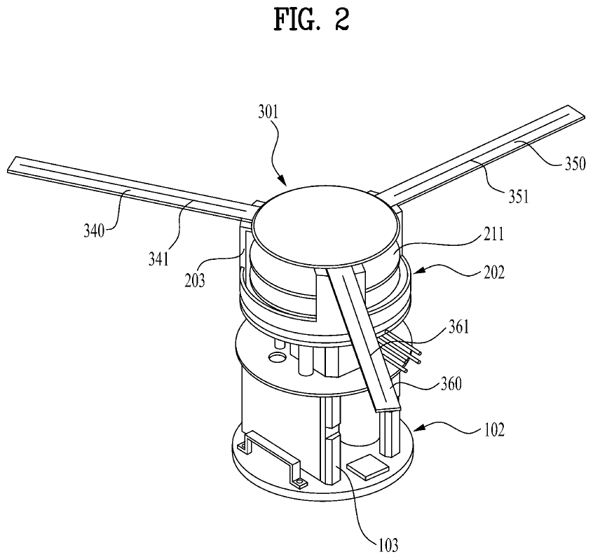

FIG. 2 is a perspective view illustrating a second embodiment of a rotating display device applicable to the present disclosure.

FIG. 2 illustrates a rotating display device in which light-emitting element arrays 341, 351, and 361 (hereinafter, referred to as a second light-emitting element arrays) are provided at respective blade panels 340, 350 and 360 (hereinafter, referred to as second panels) in the longitudinal directions of the respective panels.

Broadly speaking, the rotary display device may include a fixed unit 102 including a motor 110 (see FIG. 7), a rotary unit 202, which is positioned on the fixed unit 102 and is rotated by a motor 110, and a light source module 301, which includes second light-emitting element arrays 341, 351, and 361 and displays an after-image to realize a display by rotation thereof.

As illustrated in the drawing, the light source module 301 may include one or more second bar-shaped panels 340, 350 and 360, which are radially disposed about the rotational center thereof, and the second light-emitting element arrays 341, 351, and 361, which are respectively disposed on the second panels 340, 350 and 360 in the respective longitudinal directions thereof.

In this way, the light source module 301 may be composed of the second panels 340, 350, and 360 on which the second light-emitting element arrays 341, 351, and 361 are respectively arranged.

Although the light source module 301 may be composed of a plurality of second panels 340, 350 and 360, the light source module 301 may also be composed of a single panel on which a light-emitting element array is disposed. When the light source module 301 is constituted as a plurality of panels, as shown in FIG. 2, a plurality of sub-images, which are allocated to the plurality of panels, may realize one single frame image. Accordingly, the light source module 301 may be rotated at a rotational speed lower than the case in which the same frame is realized by a single panel.

Individual pixels may be longitudinally disposed in each of the second light-emitting element arrays 341, 251 and 361 of the second panels 340, 350 and 360. The subpixels constituting each of the pixels may be arranged in a direction perpendicular to the longitudinal direction. Meanwhile, the subpixels constituting each of the pixels may be arranged in a direction parallel to the longitudinal direction.

A concrete description of the second light-emitting element arrays 341, 351, and 361 provided in the light source module 301 will be made in detail later.

The fixed unit 102 may constitute a frame structure. In other words, the fixed unit 102 may include a plurality of frames 103, which are designed to be coupled to each other to constitute the fixed unit 102.

The frame structure may provide a space, in which the motor 110 is mounted, and a space in which the power supply 120, the RF module 126 (see FIG. 7), and the like are mounted.

Furthermore, the fixed unit 102 may be provided with a weight (not shown) configured to reduce the influence of high-speed rotation of the rotary unit 202.

Similarly to the fixed unit 102, the rotary unit 202 may also constitute a frame structure. In other words, the rotary unit 202 may include a plurality of frames 203, which are designed to be coupled to each other to constitute the rotary unit 202.

The frame structure may provide a space in which the drive circuit 210 configured to drive the second light-emitting arrays 341, 351, and 361 to realize a display, is mounted.

The driving shaft of the motor 110 may be fixed to a shaft-fixing portion (not shown) formed at the frames 203 of the rotary unit 202. As a result, the driving shaft of the motor 110 may be positioned coaxially with the rotational center of the rotary unit 202.

The light source module 301 may be fixed to the upper sides of the frames 201.

Although the second embodiment of the present disclosure has been described heretofore with reference to FIG. 2, the second embodiment may be substantially identical to the first embodiment, with the exception of the difference in the configuration of the light source module 301. Accordingly, the configuration of the first embodiment may be similarly applied to components of the second embodiment that have not been described herein.

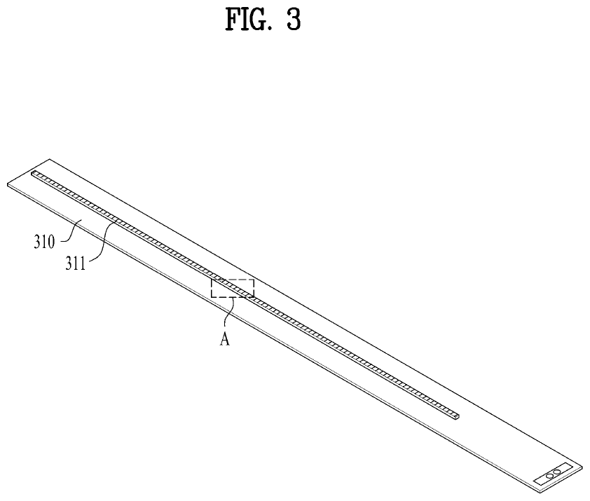

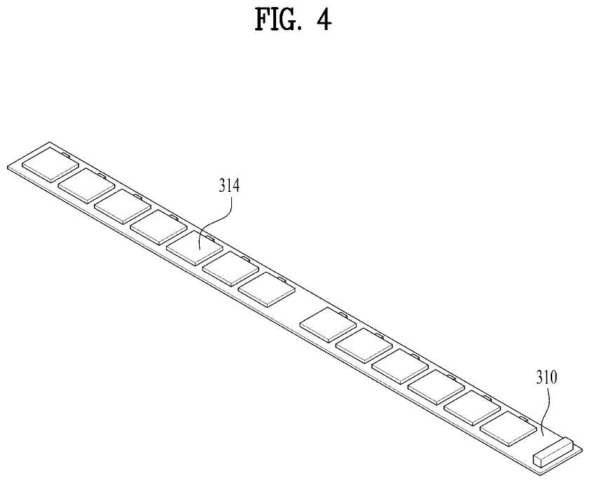

FIG. 3 is a perspective view showing the front surface of a light source module according to the first embodiment of the present disclosure, and FIG. 4 is a perspective view showing the rear surface of the light source module according to the first embodiment of the present disclosure.

Although FIGS. 3 and 4 illustrate the first panel 310 of the first embodiment as an example, the configuration illustrated in FIGS. 3 and 4 may be identically applied not only to the other panels 320 and 330 but also to the panels 340, 350, and 360 of the second embodiment. That is, the light source module of the first embodiment and the light source module of the second embodiment may have the same configuration.

In other words, each of the first light-emitting element arrays 311 and each of the second light-emitting element arrays 341, 351, and 361 may have the same structure. Hereinafter, the light source module will be described based on the first light-emitting element array 311.

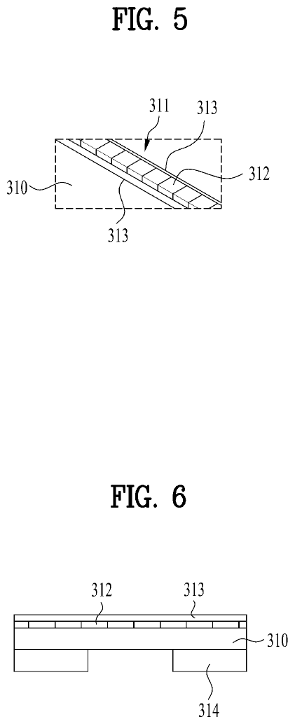

FIG. 3 illustrates one panel 310 forming the light source module 300. As mentioned above, the panel 310 may be a printed circuit board (PCB). A plurality of light-emitting elements 312 (refer to FIG. 5) may be mounted on the panel 310 so as to be disposed in one direction to form pixels, thereby constituting the light-emitting element array 311. Here, a light-emitting diode (LED) may be used as the light-emitting element.

That is, the light-emitting elements 312 are disposed in one direction on one panel 310 to form individual pixels, with the result that the light-emitting element array 311 may be provided so as to be linearly mounted.

FIG. 4 illustrates the rear surface of the panel 310. Drivers 314 for driving the light-emitting elements 312 may be mounted on the rear surface of the panel 310, which constitutes the light source module.

Since the drivers 314 are mounted on the rear surface of the panel 310, as described above, the drivers 314 may not interfere with a light-emitting surface, the influence on light emission from the light sources (the light-emitting elements) 312 due to interference may be minimized, and the area of the panel 310 may be minimized. The panel 310, having a small area, may improve the transparency of the display.

Meanwhile, the front surface of the panel 310, on which the light-emitting element array 311 is mounted, may be processed into a dark color (e.g. black) in order to improve the contrast ratio and the color expression of the display, thereby maximizing the effect of the light sources.

FIG. 5 is an enlarged view of portion A in FIG. 3, and FIG. 6 is a cross-sectional view of the light source module according to the present disclosure.

Referring to FIG. 5, it can be seen that the individual light-emitting elements 312 are mounted linearly in one direction (the longitudinal direction of the panel). In this case, a protective portion 313 may be located outside the light-emitting elements 312 in order to protect the light-emitting elements 312.

Red, green, and blue light-emitting elements 312 may form one pixel in order to realize natural colors, and the individual pixels may be mounted in one direction on the panel 310.

Referring to FIG. 6, the light-emitting elements 312 may be protected by the protective portion 313. Further, as described above, the drivers 314 may be mounted on the rear surface of the panel 310, and may drive the light-emitting elements 312 in units of pixels or subpixels. In this case, one driver 314 may individually drive at least one pixel.

FIG. 7 is a block diagram of the rotating display device according to one embodiment of the present disclosure.

Hereinafter, a configuration for driving the rotating display device will be described briefly with reference to FIG. 7. Although this configuration will be described with reference to the first embodiment described above, the same may also be identically applied to the second embodiment.

First, a driving circuit 210 may be mounted to the fixed unit 100. The driving circuit 120 may include a power supply. The driving circuit 120 may include a wireless power transmitter 121, a DC-DC converter 122, and a voltage generator 123 for supplying individual voltages.

External power may be supplied to the driving circuit 120 and the motor 110.

In addition, an RF module 126 may be provided at the fixed unit 100, so that the display may be driven in response to a signal transmitted from the outside.

Meanwhile, a means for sensing rotation of the rotary unit 200 may be provided at the fixed unit 100. Infrared radiation may be used to sense rotation. Accordingly, an IR emitter 125 may be mounted to the fixed unit 100, and an IR receiver 215 may be mounted to the rotary unit 200 at a position corresponding to the IR emitter 125.

In addition, a (micro) controller 124 may be provided at the fixed unit 100 in order to control the driving circuit 120, the motor 110, the IR emitter 125, and the RF module 126.

Meanwhile, the rotary unit 200 may include a wireless power receiver 211 for receiving a signal from the wireless power transmitter 121, a DC-DC converter 212, and a voltage generator (LDO) 213 for supplying individual voltages.

The rotary unit 200 may be provided with an image processor 216 in order to realize an image through the light-emitting element array using RGB data of an image to be displayed. The signal processed by the image processor 216 may be transmitted to the drivers 314 of the light source module, and thus an image may be realized.

In addition, a controller 214 may be mounted to the rotary unit 200 in order to control the wireless power receiver 211, the DC-DC converter 212, the voltage generator (LDO) 213, the IR receiver 215, and the image processor 216.

The image processor 216 may generate a signal for controlling light emission from the light sources of the light source module based on data of an image to be output. At this time, the data for light emission from the light source module may be internal data or external data.

The data stored in the internal device (the rotary unit 200) may be image data pre-stored in a storage device, such as a memory (an SD-card) mounted together with the image processor 216. The image processor 216 may generate a light emission control signal based on the internal data.

The image processor 216 may transmit control signals to the drivers 314 so that the first light-emitting element arrays 311 and the second light-emitting element arrays 341, 351, and 361 display image data of a specific frame in a delayed manner.

Meanwhile, the image processor 216 may receive image data from the fixed unit 100. At this time, external data may be output through an optical data transmission device, such as a photo coupler, or an RF-type data transmission device, such as a Bluetooth or Wi-Fi device.

In this case, as mentioned above, a means for sensing rotation of the rotary unit 200 may be provided. That is, the IR emitter 125 and the IR receiver 215 may be provided as a means for detecting the rotational position (speed) of the rotary unit 200, such as an absolute rotational position or a relative rotational position, in order to output light source data suitable for each rotational position (speed) during rotation of the rotary unit 200. Alternatively, this function may also be achieved using an encoder, a resolver, or a Hall sensor.

Meanwhile, data required to drive the display may be transmitted as a signal in an optical manner at low cost using the principle of a photo coupler. That is, if the fixed unit 100 and the rotary unit 200 are provided with a light emitter and a light receiver, reception of data is continuously possible even when the rotary unit 200 rotates. Here, the IR emitter 125 and the IR receiver 215 described above may be used to transmit data.

As described above, power may be transferred between the fixed unit 100 and the rotary unit 200 in a wireless power transfer (WPT) manner.

Wireless power transfer enables the supply of power without connection of a wire using a resonance phenomenon of a coil.

To this end, the wireless power transmitter 121 may convert power into an RF signal of a specific frequency, and a magnetic field generated by current flowing through the transmission coil 130 may generate an induced current in the reception coil 220.

At this time, the natural frequency of the coil and the transmission frequency for transferring actual energy may differ from each other (a magnetic induction method).

Meanwhile, the resonant frequencies of the transmission coil 130 and the reception coil 220 may be the same (a magnetic resonance method).

The wireless power receiver 211 may convert the RF signal input from the reception coil 220 into direct current, and may transmit required power to a load.

FIG. 8 is a schematic perspective view illustrating a state in which an encoder is applied to a rotating display device according to a first embodiment of the present disclosure.

The rotating display device may be provided with an encoder 400 between a fixed unit 100 and a rotary unit 200.

When the light source module 300 (or 301 of FIG. 2) including the panel 310 provided with the above-described light-emitting element array 311 rotates and reproduces different information depending on time, the rotational speed of the light source module 300 or 301 and the synchronization of a scanning screen must match each other so that a desired image or video may always be reproduced at a constant position.

Hereinafter, the light source module 300 will be described based on the above-described rotating display device according to the first embodiment as an example. However, the encoder 400, which will be described below, may be applied to the light source module of the rotating display device according to the second embodiment or one of other types of rotating display devices.

There may be several methods of synchronizing an image and a specific position of the light source module 300 or 301, and for example, the encoder 400 using infrared light may be applied.

The encoder 400 includes a scaler 410 fixed to one of the fixed unit 100 and the rotary unit 200 and having a plurality of slits 411 formed therein, and may output a synchronization signal corresponding to the positions of the plurality of slits 411 by relative motion generated by the fixed unit 100 and the rotary unit 200.

In addition, the encoder 400 may include a header 420 having light emitters 422 that emit infrared light and light receivers 421 that receive the infrared light emitted from the light emitters 422.

As an exemplary embodiment, the header 420 may include a frame 423 that connects the light emitters 422 to the rotary unit 200. Here, the light receivers 421 may be fixed to the rotary unit 200.

By this method using infrared light, the light emitters 422 emit infrared light and the light receivers 421 cyclically receive the infrared light emitted from the light emitters 422 whenever the rotary unit 200 rotates, and thereby, a synchronization signal and a light emitting signal may be processed to enable an image to always be scanned at a constant position.

For example, the light emitters 422 and the light receivers 421 may be connected to the rotary unit 200 and rotate integrally with the rotary unit 200. The disc-shaped scaler 410 having the slits 411 may be located between the light emitters 422 and the light receivers 421. Here, the plurality of slits 411 may be formed at regular intervals in the scaler 410.

As described above, if the light emitters 422 and the light receivers 421 are connected to the rotary unit 200 and rotate integrally with the rotary unit 200, the scaler 410 may be located at a fixed position between the light emitters 422 and the light receivers 421. Therefore, the light receivers 421 may receive infrared light on a regular cycle through the plurality of slits 411 located at the regular intervals.

As such, the light receivers 421 may receive signals of a constant width corresponding to the width of the slits. The signals received by the light receivers 421 may be referred as synchronization signals (reference signals).

As described above, the plurality of slits 411 may be formed in the scaler 410 of the encoder 400 radially about the central point thereof in the circumferential direction, and the infrared light receivers 421 and emitters 422 connected to the rotary unit 200 may rotate integrally with the rotary unit 200. At this time, light emitted from the light emitters 422 may pass through the slits 411 of the scaler 410 and be input to the light receivers 421. Therefore, while the rotary unit 200 rotates, a number of signals corresponding to the number of the slits may be received through the light receivers 421.

Here, the image processor 216 may generate a signal for controlling light emission of light sources of the light source module based on image data to be output. Therefore, the image processor 216 may control light emission of the light sources of the light source module using the signals transmitted from the encoder 400.

That is, the image processor 216 may transmit a signal for controlling image data of a specific frame displayed by each of the first light emitting element arrays 311 or the second light emitting element arrays 341, 351, and 361 to be displayed in a delayed manner after a basic delay time using the synchronization signals (reference signals) received from the encoder 300, to the drivers 314.

Here, the basic delay time may correspond to a time from a point in time when the synchronization signals are output to a point in time when the light source module 300 actually emits light.

At this time, as illustrated, the scaler 410 may have the plurality of slits 411 arranged on two orbits to receive position information for improving screen distortion due to changes in the rotational speed of the rotary unit 200.

As such, two light emitters 422 and two light receivers 421 may be provided to receive two types of signals. That is, two pairs of the light emitters 422 and the light receivers 421 may be provided.

For example, a trigger signal (first scan line position information of the display) may be generated using one pair of the light emitter 422 and the light receiver 421 among the two light emitters 422 and the two light receivers 421.

Screen distortion due to changes in the rotational speed of the rotary unit 200 may be improved through the position information received through the pairs of the light emitters 422 and the light receivers 421. In addition, the display may be synchronized depending on the rotational speed through the first scan line position information of the display (trigger signal) received through the pairs of the light emitters 422 and the light receivers 421. A detailed description of this will be omitted.

As described above, the light receivers 421 may receive signals of a constant width corresponding to the width of the slits. The signals received by the light receivers 421 may be referred as synchronization signals (reference signals). In this way, the reference signals may be generated on a regular cycle corresponding to the slits 411 by the light emitters 422, the light receivers 421, and the scaler 410.

However, due to mechanical tolerances among the fixed unit 100, the rotary unit 200, and the encoder 400, the rotation axis and the axis of the encoder 400 may not perfectly coincide, and may thus cause screen shaking of the display.

For example, if the scaler 410 is used in the encoder 400, as in the embodiment described above, the scaler 410 and the rotary unit 200 are installed so that the axes thereof coincide, but a certain mechanical tolerance may occur between the central axis of the scaler 410 and the axis of the rotary unit 200. That is, if the axis of the scaler 410 deviates from the axis of the rotary unit 200, the reference signals may not be generated at the correct timing, and thus, screen shaking may occur.

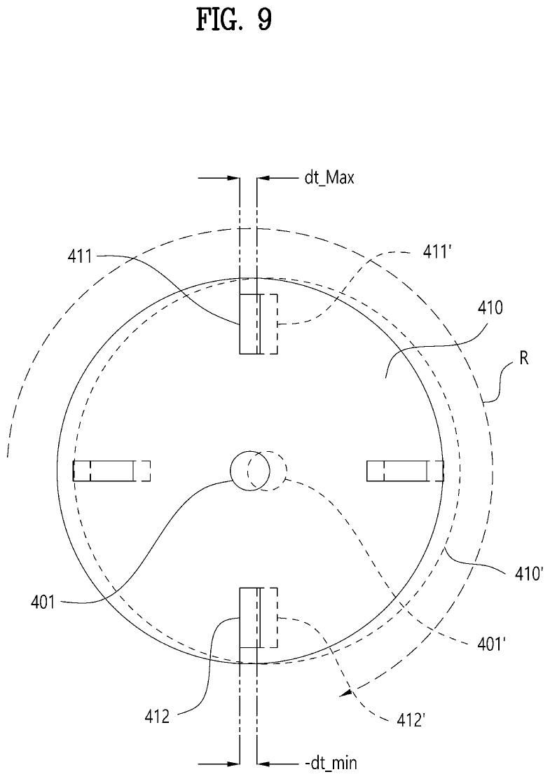

FIGS. 9 to 12 are views for explaining a phenomenon that occurs if the axis of the scaler deviates from the axis of the rotary unit in the rotating display device.

First, FIG. 9 illustrates the scaler 410 at an accurate position and a scaler 410′ at a deviated position. The scaler 410 should ideally be installed at the exact position of a central axis 401, but the scaler 410′ is usually installed at a central axis 401′ that deviates due to a mechanical tolerance when the scaler 410 is installed.

Hereinafter, a phenomenon that occurs when the central axis 401 of the encoder scaler 410 deviates as indicated by the dotted line will be described. Here, for convenience of explanation, a case with four slits will be described briefly.

If the encoder 410 having four slits deviates to the position 410′, when the light emitters 422 and the light receivers 421 of the encoder 410 rotate in the clockwise direction R to measure the positions of the slits, the slit 411 in the 12 o'clock direction deviates to the position 411′ and thus a signal reception time therethrough may be delayed from the normal reception time.

That is, the light emitter 422 may always emit infrared light and the infrared light is blocked by the scaler 410 and is not received by the light receiver 421, but when the light emitter 422 and the light receiver 421 are located at the position of the slit 411, the light receiver 421 may receive the infrared light emitted from the light emitter 422 for a time corresponding to the width of the slit 411. At this time, because the position of the slit 411 deviates to the position 411′, the light receiver 421 does not receive the infrared light at the original position of the slit 411, and receives the infrared light when the light receiver 421 reaches the deviated slit position 411′.

On the other hand, because the slit 412 in the 6 o'clock direction deviates to the position 412′, when measuring the position of this slit, the position of the slit may be measured at a time advanced from the normal reception time.

That is, when the light emitter 422 and the light receiver 421 are located at the position of the slit 412, the light receiver 421 may receive infrared light emitted from the light emitter 422 for a time corresponding to the width of the slit 412. At this time, because the position of the slit 412 deviates to the position 412′, the light receiver 421 receives the infrared light when the light receiver 421 reaches the deviated slit position 412′ before reaching the original position of the slit 412.

Such a change in the reception time including delay and advance may be maximum (dt_Max) at the slit 411 in the 12 o'clock direction and minimum (dt_Min) at the slit 412 in the 6 o'clock direction. However, it may be seen that the absolute value of the change in the reception time may also be maximum at the slit 412 in the 6 o'clock direction.

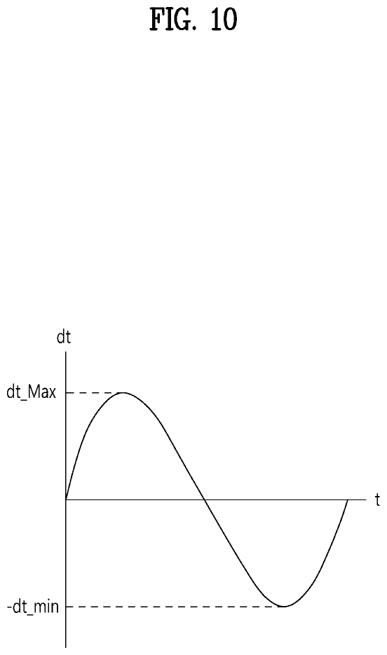

Assuming that there are a larger number of slits in the scaler 410, the change in the reception time dt may be represented as a graph, as shown in FIG. 10.

The graph shown in FIG. 10 continuously shows the degree of deviation of the reception time assuming that there are many slits.

That is, the degree of deviation of the reception time at the slit in the 3 o'clock direction and the slit in the 9 o'clock direction, where deviation of the reception time occurs in the same direction as the measured slit width, becomes substantially 0.

If measurement starts at the slit in the 3 o'clock direction, that is, if the position of the slit in the 3 o'clock direction is considered as the origin of the graph, the delay time may gradually increase as the header rotates past the position of the slit in the 3 o'clock direction, and may become maximum at the slit 411 in the 12 o'clock direction.

Thereafter, the delay time may gradually decrease and become 0 again at the slit in the 3 o'clock direction. That is, light reception by the light receiver 422 at the exact position may occur. However, the reception time of the light receiver 422 may be advanced from the actual time and be maximally advanced at the slit in the 6 o'clock direction. Thereafter, the degree of the advance of the reception time may become smaller again and become actually 0 at the slit in the 9 o'clock direction.

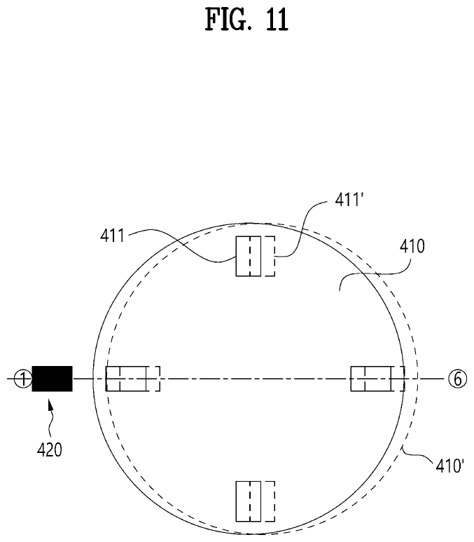

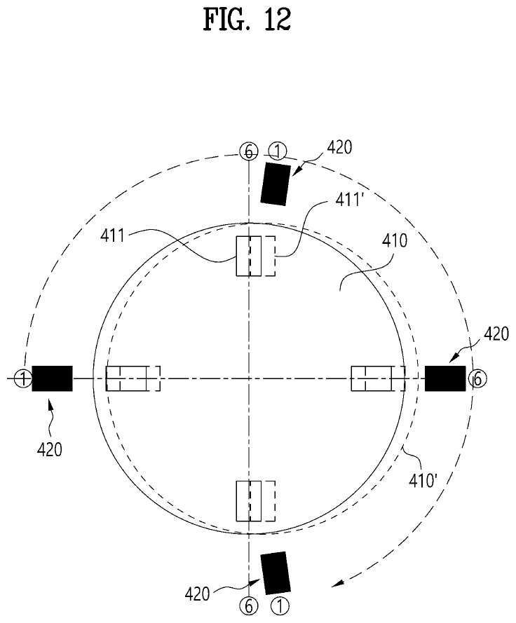

FIGS. 11 and 12 shows image shaking due to deviation of the encoder.

FIG. 11 illustrates a state in which two panels \textcircled{1} and \textcircled{6} and the header 420 including the light emitter 422 and the light receiver 421 rotate together in the clockwise direction and light is emitted through the scaler 410.

At this time, because the scaler 410 deviates to the position 410′, if light is emitted through synchronization using the deviated scaler 410′, light emitting positions at the slit 411 in the 12 o'clock direction and the slit in the 6 o'clock direction deviate. Therefore, the two panels \textcircled{1} and \textcircled{6} provided with light-emitting arrays may not emit light at the same position, and thus cause image shaking.

That is, referring to FIG. 12, light reception by the light receiver 422 occurs when the header 420 is located at the actual position 411′ of the slit in the 12 o'clock direction, and thus, the panel \textcircled{1} emits light at the delayed position. However, at this time, the panel \textcircled{6} may not emit light because it has already passed the slit at the deviated position. Therefore, the two panels \textcircled{1} and \textcircled{6} may not emit light at the same position at the exact timing.

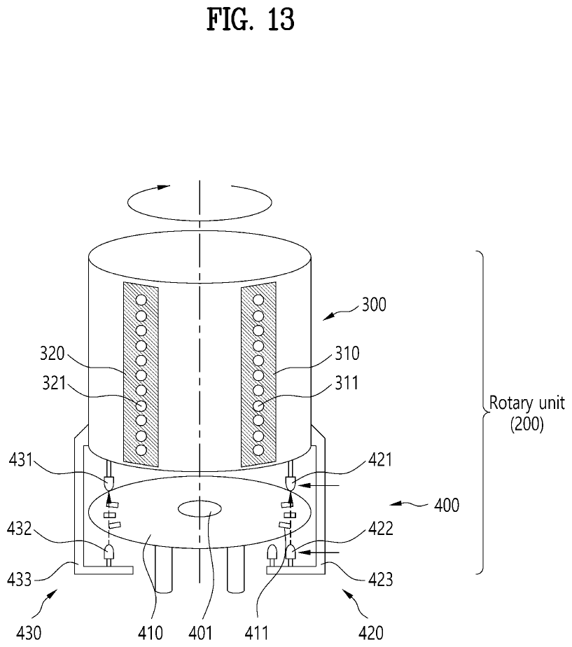

FIG. 13 is a schematic perspective view illustrating a state in which an encoder is applied to a rotating display device according to a second embodiment of the present disclosure.

Referring to FIG. 13, the rotating display device may be provided with an encoder 400 between a fixed unit 100 and a rotary unit 200.

The encoder 400 includes a scaler 410 fixed to one of the fixed unit 100 and the rotary unit 200 and having a plurality of slits 411 formed therein, and may output a synchronization signal corresponding to the positions of the plurality of slits 411 by relative motion generated by the fixed unit 100 and the rotary unit 200.

In addition, the encoder 400 may include a first header 420 having a first light emitter 422 that emits infrared light and a first light receiver 421 that receives the infrared light emitted from the first light emitter 422, and a second header 430 having a second light emitter 432 and a second light receiver 431 that receives infrared light emitted from the second light emitter 432.

As an exemplary embodiment, the second header 430 may include a frame 433 that connects the second light emitter 432 to the rotary unit 200. Here, the light receiver 431 may be fixed to the rotary unit 200. In addition, in the same manner as the first embodiment, the first header 420 may include a frame 423 that connects the second light emitter 422 to the rotary unit 200.

By this method using infrared light, the first header 420 and the second header 430 cyclically generate synchronization signals whenever the rotary unit 200 rotates, and thereby, a light emitting signal may be processed to enable an image to always be scanned at a constant position. However, this is exemplary, and additional headers may be provided in addition to the first header 420 and the second header 430.

As an exemplary embodiment, the first header 420 and the second header 430 may be connected to the rotary unit 200 and rotate integrally with the rotary unit 200. The disc-shaped scaler 410 having the slits 411 may be located between the first light emitter 422 and the first light receiver 421 of the first header 420 and between the second light emitter 432 and the second light receiver 431 of the second header 430. Here, the plurality of slits 411 may be formed at regular intervals in the scaler 410.

As described above, if the first header 420 and the second header 430 are connected to the rotary unit 200 and rotate integrally with the rotation portion 200, the scaler 410 may be located at a fixed position with respect to the first header 420 and the second header 430. Therefore, the first header 420 and the second header 430 may receive infrared light on a regular cycle through the plurality of slits 411 located at the regular intervals.

As such, the first light receiver 421 of the first header 420 and the second light receiver 431 of the second header 430 may receive signals of a constant width corresponding to the width of the slits 411. The signals received by the first light receiver 421 and the second light receiver 431 may be referred as synchronization signals (reference signals).

As described above, the plurality of slits 411 may be formed in the scaler 410 of the encoder 400 radially about a central point 401 in the circumferential direction, and the first header 420 and the second header 430 connected to the rotary unit 200 may rotate together with the rotary unit 200.

The first header 420 and the second header 430 may be located at a first side and a second side of the scaler 410. As an exemplary embodiment, the first side may be located at an opposite point to the second side on the scaler 410.

At this time, light emitted from the first light emitter 422 may pass through the slit 411 of the scaler 410 and be input to the first light receiver 421. In addition, light emitted from the second light emitter 432 may pass through the slit 411 of the scaler 410 and be input to the second light receiver 431.

Therefore, while the rotary unit 200 rotates, two signals may be received per slit through the first light receiver 421 and the second light receiver 431. The signal received by the first light receiver 421 may be referred to as a first synchronization signal, and the signal received by the second light receiver 431 may be referred to as a second synchronization signal. That is, the synchronization signals may include the first synchronization signal and the second synchronization signal corresponding two slits among the plurality of slits 411.

That is, the encoder may include the first header 420 that generates the first synchronization signal and the second header 430 that generates the second synchronization signal.

As described above with reference to FIGS. 9 to 12, the scaler 410 should ideally be installed at the exact position of a central axis 401, but the scaler 410′ is usually installed at a central axis 401′ that deviates due to a mechanical tolerance when the scaler 410 is installed. Therefore, two panels 310 and 320 provided with light-emitting element arrays 311 and 321 may not emit light at the same position, and thus cause image shaking.

In addition, as the central axis 401 of the scaler 410 deviates from the axis of the rotary unit 200, deviations of the synchronization signals output from the encoder 400 may occur.

At this time, the image processor 216 may generate a signal for controlling light emission of light sources of the light source module based on image data to be output. The image processor 216 may generate an image output signal for controlling light emission of the light source module 300 at a delay time including the average value of the deviations of synchronization signals output from the encoder 400.

Therefore, the image processor 216 may control light emission of the light sources of the light source module using the signals transmitted from the encoder 400.

That is, the image processor 216 may transmit a signal for controlling image data of a specific frame displayed by each of the first light emitting element arrays 311, 321, and 331 or the second light emitting element arrays 341, 351, and 361 to be displayed in a delayed manner after such a delay time using the synchronization signals (reference signals) received from the encoder 300, to the drivers 314.

Here, the delay time may further include the above-described basic delay time. That is, the basic delay time may correspond to a time from a point in time when the synchronization signals are output to a point in time when the light source module 300 actually emits light.

The image processor 216 may generate an image output signal for controlling light emission of the light sources of the light source module 300 at a point in time obtained by adding the delay time to a point in time when one of the first synchronization signal and the second synchronization signal is detected first.

In addition, the image processor 216 may generate an image output signal for controlling light emission of the light sources of the light source module 300 after the delay time obtained by adding the basic delay time and the average value to the point in time when one of the first synchronization signal and the second synchronization signal is detected first.

As such, the image processor 216 may generate the image output signal for controlling light emission of the light source module 300 at the delay time that includes the average value of the deviations of the synchronization signals output from the encoder, so that an encoder signal of a normal position that is always delayed by a constant amount of time may be processed. Therefore, even if the axis of the encoder 400 deviates, the normal position is calculated and the processed encoder signal is output after delay of a certain time, thereby being capable of alleviating or preventing screen shaking.

The details of controlling the light source module 300 using the synchronization signals of the encoder 400 by the image processor 216 or the controller 214 will be described in detail later.

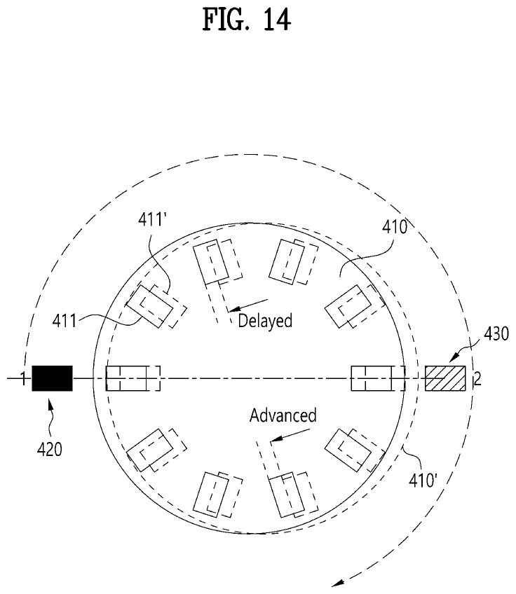

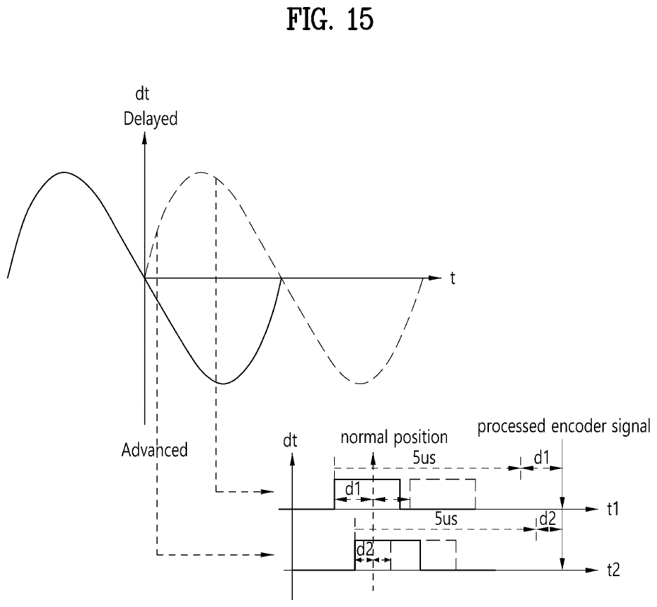

FIGS. 14 and 15 are views illustrating one example of a process of generating an image output signal in the rotating display device according to second embodiment of the present disclosure.

As described above, the first header 420 and the second header 430 may be located opposite each other with respect to the scaler 410.

Referring to FIG. 14, an example in which 10 slits 411 are formed in the scaler 410 is shown. This number of slits 411 is exemplary, and a larger number or smaller number of slits 411 may be provided.

In this state, the scaler 410 may be located at the position 410′ deviating from the exact position thereof due to a mechanical tolerance. Accordingly, the position of the slit 411 may also deviate to the position 411′. At this time, the first header 420 and the second header 430 may rotate together with the rotary unit 200. For example, as shown in the arrow, the rotary unit 200 may rotate in the clockwise direction.

As described above with reference to FIGS. 9 to 12, the synchronization signal output from the encoder 400 does not cause a timing deviation at the slits 411 located in the same direction as the deviation direction of the scaler 410, for example, the slit in the 9 o'clock direction and the slit in the 3 o'clock direction, but delay (slowing down) or advance of the synchronization signal may occur at other positions.

Referring to FIG. 15, the change dt in the reception time at each header 420 or 430 including the delay (slowing down) or advance of the synchronization signal is represented as a graph. That is, assuming that there are a larger number of slits 411 in the scaler 410, the change in the reception time dt at each header 420 or 430 may be represented as a graph, as shown in FIG. 15.

The graph shown in FIG. 15 continuously shows the degree of deviation of the reception time assuming that there are many slits.

If measurement starts at the slit in the 3 o'clock direction, that is, if the position of the slit in the 3 o'clock direction is considered as the origin of the graph, the delay time may gradually increase as the header rotates past the position of the slit in the 3 o'clock direction, and may become maximum at the slit 411 in the 12 o'clock direction. Thereafter, the delay time may gradually decrease and become 0 again at the slit in the 3 o'clock direction.

At this time, referring to FIG. 15, signals received by the two headers 420 and 430 are indicated by the solid line and the dotted line.

Referring to a signal diagram shown in the lower region of FIG. 15, it may be confirmed that two signals having a certain width corresponding to the slit width are received by the two headers 420 and 430 at the positions of two slits at two timings t1 and t2.

Here, if the position where the scaler 410 is installed without deviation is referred to as a normal position, the positions received by the two headers 420 and 430 through the scaler 410 installed at a deviated position may correspond to positions that are behind or ahead of the normal positions of the corresponding slits by a deviation.

That is, at the timing t1, a synchronization signal (first synchronization signal) may be detected by the first header 420 at a time that is advanced from the time when the signal is detected at the normal position by a deviation d1, and a synchronization signal (second synchronization signal) may be detected by the second header 430 at a time that is delayed from the time when the signal is detected at the normal position by the deviation d1.

In addition, at the timing t2, a synchronization signal (first synchronization signal) may be detected by the first header 420 at a time that is advanced from the normal position by a deviation d2 smaller than the deviation d1, and a synchronization signal (second synchronization signal) may be detected by the second header 430 at a time that is delayed from the normal position by the deviation d2 smaller than the deviation d1.

In this way, the two headers 420 and 430 always have the deviation d1 or d2 of the same size for delayed or advanced detection. For example, at the timing t1, the deviation d1 for advanced detection in the first header 420 is the same as the deviation d1 for delayed detection. That is, at the same timing, the amount of the delayed (or advanced) time of the signal (first synchronization signal) received by the first header 420 is the same as the amount of the advanced (or delayed) time by which the signal (second synchronization signal) received by the second header 430. In other words, the deviation of the first synchronization signal and the deviation of the second synchronization signal are opposite in direction and are the same in magnitude.

Therefore, it may be confirmed that the average value of the synchronization signals having such deviations may be a signal (or a point in time of the signal) at the normal position. As a result, an encoder synchronization signal at the normal position without deviation may be obtained by calculating the average position between the two synchronization signals.

However, because both the advanced signal and the delayed signal at the corresponding timing are received and then processed (average value calculation), the encoder signal at the normal position may not be output. Therefore, instead, a new encoder signal that is output after a certain time from the normal position may be generated.

That is to say, a point in time obtained by adding a point in time obtained by dividing a time difference between two encoder reception pulses by 2 to a certain delay time (basic delay time; for example, 5 μm) for calculation based on a first input pulse (first synchronization signal) indicated by the solid line may be an encoder synchronization signal that is always delayed by a constant amount of time from a time due to the normal position.

Accordingly, the image processor 216 may output an image output signal of the light source module 300 after the delay time obtained by adding the basic delay time (5 μm) and the average value of the first synchronization signal and the second synchronization signal to a point in time when one of the first synchronization signal and the second synchronization signal (in this case, the first synchronization signal indicated by the solid line) is detected first.

According to the processed and delayed synchronization signal, even if the axis of the encoder scaler 410 deviates, the normal position is calculated and the image output signal is output after delay of a certain time, thereby being capable of alleviating or preventing screen shaking.

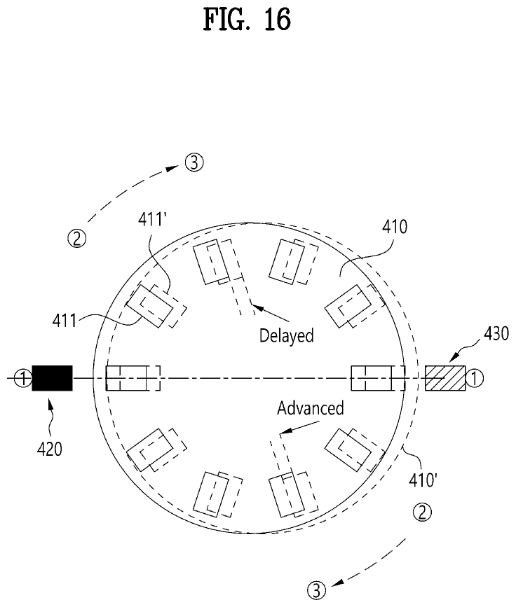

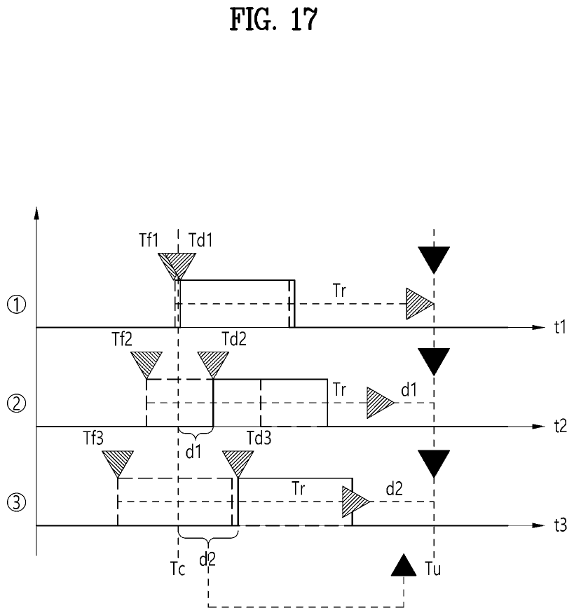

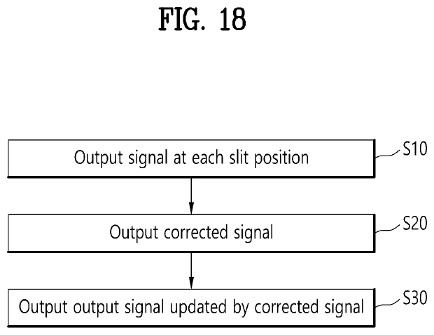

FIGS. 16 and 17 are views illustrating another example of a process of generating an image output signal in the rotating display device according to the second embodiment of the present disclosure. FIG. 18 is a flowchart of a process of generating an image output signal.

Referring to FIG. 16, an example in which 10 slits 411 are formed in the scaler 410 is shown. As described above, this number of slits 411 is exemplary, and a larger number or smaller number of slits 411 may be provided.

In this state, the scaler 410 may be located at the position 410′ deviating from the exact position thereof due to a mechanical tolerance. Accordingly, the position of the slit 411 may also deviate to the position 411′. At this time, the first header 420 and the second header 430 may rotate together with the rotary unit 200. For example, as shown in the arrow, the rotary unit 200 may rotate in the clockwise direction.

FIG. 16 shows an example in which the headers 420 and 430 rotate in the clockwise direction to output synchronization signals for the positions of the slits 411 and 411′ at three timings t1, t2, and t3 corresponding to positions indicated as \textcircled{1}, \textcircled{2}, and \textcircled{3} (S10 of FIG. 18).

The case of FIG. 16 is substantially the same as the case illustrated in FIG. 14, but shows a more specific example in which the headers 420 and 430 of the encoder 400 output synchronization signals at the three timings t1, t2, and t3.

FIG. 17 shows the timings of the pulse signals (synchronization signals) of FIG. 16. If the scaler 410 or the encoder 400 is installed at the position 410′ that deviates to the right as in the case of FIG. 16, when the headers 420 and 430 are located at the position \textcircled{1} (at the timing t1), the first synchronization signal (indicated by the dotted line) and the second synchronization signal (indicated by the solid line) may be substantially received at times Tf1 and Td1.

Thereafter, when the headers 420 and 430 are located at the position \textcircled{2} (at the timing t2), the first synchronization signal (indicated by the dotted line) may be received at a time Tf2 that is advanced from a time Tc due to the normal position. In addition, the second synchronization signal (indicated by the solid line) may be received at a delayed time Td2.

At this time, a value obtained by dividing a time difference between the reception times Tf2 and Td2 of the first synchronization signal and the second synchronization signal by 2 corresponds to d1. As described above, the magnitudes of the deviations of the reception times are the same for the first synchronization signal and the second synchronization signal.

Thereafter, when the headers 420 and 430 are located at the position \textcircled{3} (at the timing t3), the first synchronization signal (indicated by the dotted line) may be received at a time Tf3 that is advanced from the time Tc due to the normal position. In addition, the second synchronization signal (indicated by the solid line) may be received at a delayed time Td3.

At this time, a value obtained by dividing a time difference between the reception times Tf3 and Td3 of the first synchronization signal and the second synchronization signal by 2 corresponds to d2.

In this case, as described above, a new encoder signal (corrected signal) that is output after a certain time (time Tu) at the normal position may be generated and output (S20 of FIG. 18).

That is to say, a point in time obtained by adding a value obtained by dividing a time difference between two encoder reception pulses by 2 to a certain delay time (basic delay time Tr) for calculation based on a first input pulse (first synchronization signal) indicated by the solid line may be an encoder synchronization signal that is always delayed by a constant amount of time from the normal position.

In the above case, a point in time obtained by adding the average value dl or d2 to Tr from the first synchronization signal (dotted line) that has been received first corresponds to a newly processed output point in time Tu of the light source module 300, and this newly processed output point in time may always be a constant point in time.

That is, a point in time obtained by adding the average value d1 to Tr from the first synchronization signal (dotted line) that has been received first at the position \textcircled{2} and a point in time obtained by adding the average value d2 to Tr from the first synchronization signal (dotted line) that has been received first at the position \textcircled{3} are the same (Tu). The first synchronization signal (dotted line) and the second synchronization signal (solid line) are received simultaneously at the position \textcircled{1}, and thus, even in this case, a point in time obtained by adding the average value (in this case, 0) to Tr from the first synchronization signal (dotted line) that has been received first is also the same as the position of Tu.

Accordingly, the image processor 216 may output an updated image output signal (driving signal) of the light source module 300 after the delay time Tu obtained by adding the basic delay time Tr and the average value d1 or d2 of the two signals to the detection point in time of one signal that is detected first among the first synchronization signal and the second synchronization signal (in this case, the first synchronization signal) (S30 of FIG. 18).

In this way, according to the delayed synchronization signal that occurs after a certain time Tu, even if the axis of the encoder scaler 410 deviates, the normal position is calculated and the driving signal is output after delay of a certain time, thereby being capable of alleviating or preventing screen shaking.

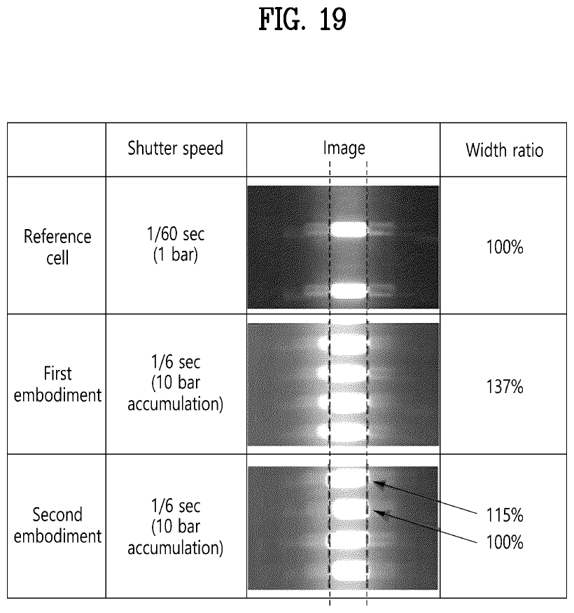

FIG. 19 is a table showing actual photographed states of the light source modules of the rotating display devices according to the embodiments of the present disclosure.

The image of a light source module (reference cell) including one panel 310 provided with the light-emitting element array 311 serving as a reference corresponds to a case in which a shutter speed is 1/60 sec. In FIG. 19, the actual width of the light-emitting element array is indicated by the dotted line.

At such a fast shutter speed, one panel 310 (1 bar) may be photographed with a width corresponding to the actual width of the light-emitting element array (width ratio of 100%). Therefore, the photographed image may have a width ratio corresponding to the actual width of the light-emitting element array.

At this time, if the shutter speed is lowered to ⅙ sec, a state in which the light-emitting element array is accumulated 10 times at one view point may be photographed. Two lower images are images photographed in the state in which the shutter speed is lowered to ⅙ sec according to the first embodiment and the second embodiment.

According to the state of the above-described first embodiment, the width ratio of the photographed light-emitting element array may correspond to 137%. That is, in this case, screen shaking may occur in proportion to this ratio.

Further, according to the state of the above-described second embodiment, the width ratio of the photographed light-emitting element array may correspond to 115% or 100%. As such, according to the second embodiment of the present disclosure, screen shaking may be prevented or greatly alleviated.

The features, structures, effects, etc. that have been described above in the embodiments are included in at least one embodiment of the present disclosure, and are not necessarily limited to only one embodiment. Furthermore, the features, structures, effects, etc. described in each embodiment may be combined with other embodiments or modified and implemented by those skilled in the art to which the embodiments pertain. Therefore, such combinations and modifications should be interpreted as being within the scope of the present disclosure.

In addition, although the embodiments have been described above, the embodiments are merely examples and do not limit the present disclosure, and it will be apparent to those skilled in the art that various modifications and applications not exemplified above are possible within the scope of the present disclosure. For example, each component specifically exemplified in the embodiments may be modified and implemented. In addition, differences related to such modifications and applications should be interpreted as being within the scope of the present disclosure as defined in the appended claims.

### INDUSTRIAL APPLICABILITY

According to the present disclosure, it is possible to provide a rotating display device using light sources, such as micro-LEDs.

1. A rotating display device comprising:
a fixed unit comprising a motor;
a rotary unit located on the fixed unit and rotated by the motor;
a light source module coupled to the rotary unit and comprising a light-emitting element array configured to display an image using an after-image caused by the rotation of the rotary unit;
an encoder comprising a scaler fixed to any one of the fixed unit and the rotary unit and having a plurality of slits formed therein, and configured to output synchronization signals corresponding to positions of the plurality of slits caused by relative motion generated by the fixed unit and the rotary unit; and
an image processor configured to generate an image output signal configured to control light emission of the light source module at a point in time comprising a delay time comprising an average value of deviations of the synchronization signals output from the encoder.

2. The rotating display device of claim 1, wherein the synchronization signals comprise a first synchronization signal and a second synchronization signal corresponding to two slits among the plurality of slits.

3. The rotating display device of claim 2, wherein the image processor is configured to generate the image output signal at a point in time obtained by adding the delay time to a detection time of a signal first detected among the first synchronization signal and the second synchronization signal.

4. The rotating display device of claim 2, wherein the encoder comprises a first header configured to generate the first synchronization signal and a second header configured to generate the second synchronization signal.

5. The rotating display device of claim 4, wherein:
the first header is located at a first side of the scaler and comprises a first light emitter and a first light receiver; and
the second header is located at a second side of the scaler and comprises a second light emitter and a second light receiver.

6. The rotating display device of claim 5, wherein the first side is located at an opposite point to the second side on the scaler.

7. The rotating display device of claim 1, wherein the delay time comprises a basic delay time corresponding to a time from a point in time when the synchronization signals are output to a point in time when the light source module actually emits light.

8. The rotating display device of claim 7, wherein the image processor is configured to output the image output signal after the delay time obtained by adding the basic delay time and the average value to a detection time of a signal first detected among the first synchronization signal and the second synchronization signal.

9. The rotating display device of claim 1, wherein the scaler has a disc shape configured such that the plurality of slits is formed in a circumferential direction thereof.

10. The rotating display device of claim 1, wherein the encoder comprises:
a light emitter configured to continuously emit light; and
a light receiver configured to receive the light emitted from the light emitter.

11. The rotating display device of claim 1, wherein the light source module comprises a light-emitting element array coupled to the rotary unit, and disposed in a longitudinal direction on at least one panel arranged radially or at least one panel arranged along a cylindrical surface.

12. A rotating display device comprising:
a fixed unit comprising a motor;
a rotary unit located on the fixed unit and rotated by the motor;
a light source module coupled to the rotary unit and comprising a light-emitting element array configured to display an image using an after-image caused by the rotation of the rotary unit;
an encoder comprising a plurality of slits and configured to output synchronization signals comprising a first synchronization signal and a second synchronization signal corresponding positions of to two slits among the plurality of slits, caused by relative motion generated by the fixed unit and the rotary unit; and
an image processor configured to generate an image output signal to control light emission of the light source module at a point in time comprising a delay time comprising an average value of deviations of the first synchronization signal and the second synchronization signal output from the encoder.

13. The rotating display device of claim 12, wherein the image processor is configured to generate the image output signal at a point in time obtained by adding the delay time to a detection time of a signal first detected among the first synchronization signal and the second synchronization signal.

14. The rotating display device of claim 12, wherein the encoder comprises a first header configured to generate the first synchronization signal and a second header configured to generate the second synchronization signal.

15. The rotating display device of claim 14, further comprising a scaler fixed to any one of the fixed unit and the rotary unit and having the plurality of slits formed therein, wherein:
the first header is located at a first side of the scaler and comprises a first light emitter and a first light receiver; and
the second header is located at a second side of the scaler and comprises a second light emitter and a second light receiver.

16. The rotating display device of claim 15, wherein the first side is located at an opposite point to the second side on the scaler.

17. The rotating display device of claim 12, wherein the delay time comprises a basic delay time corresponding to a time from a point in time when the synchronization signals are output to a point in time when the light source module actually emits light.

18. The rotating display device of claim 17, wherein the image processor is configured to output the image output signal after the delay time obtained by adding the basic delay time and the average value to a detection time of a signal first detected among the first synchronization signal and the second synchronization signal.

19. The rotating display device of claim 12, wherein the scaler has a disc shape configured such that the plurality of slits is formed in a circumferential direction thereof.

20. The rotating display device of claim 12, wherein the light source module comprises a light-emitting element array coupled to the rotary unit, and disposed in a longitudinal direction on at least one panel arranged radially or at least one panel arranged along a cylindrical surface.
